(19) United States
(12) Patent Application Publication
(10) Pub. No.: US 2026/0253949 A1
(43) Pub. Date: Aug. 27, 2026

(54) GARNET-TYPE SOLID-STATE ELECTROLYTE POWDER, METHOD FOR PREPARING THE SAME, AND LITHIUM-ION CELL USING THE SAME

(71) Applicant: China Glaze Co., Ltd., Chutung (TW)

(72) Inventors: Pavitra SRIVASTAVA, Taipei City (TW); Yuan-Ting HUNG, Kaohsiung City (TW); Ru-Shi LIU, New Taipei City (TW); Kun-Ta TSAI, Chutung (TW); Sung-Yu TSAI, Chutung, Hsinchu (TW)

(21) Appl. No.: 19/538,519

(22) Filed: Feb. 12, 2026

Related U.S. Application Data
(60) Provisional application No. 63/762,764, filed on Feb. 25, 2025.

(30) Foreign Application Priority Data
Sep. 24, 2025 (TW) 114136806

(51) Int. Cl. H01M 10/0562; H01M 10/0525

(52) U.S. Cl. CPC H01M 10/0562; H01M 10/0525; H01M 2300/0071

(57) ABSTRACT

A garnet-type solid-state electrolyte powder is provided. The garnet-type solid-state electrolyte powder is lithium lanthanum zirconium oxide-based solid-state electrolyte powder with a passivation layer on its surface, wherein the thickness of the passivation layer is greater than 0 nm and 10 nm or less. A lithium-ion cell using the garnet-type solid-state electrolyte powder is also provided.

### CLAIM FOR PRIORITY

This application claims the benefit of U.S. Provisional Application No. 63/762,764 filed on February 25, 2025 and the benefit of Taiwan Patent Application No. 114136806 filed on September 24, 2025, the subject matters of which are incorporated herein in their entirety by reference.

### BACKGROUND OF THE INVENTION

### Field of the Invenion

The present invention provides a garnet-type solid-state electrolyte powder, especially, a garnet-type solid-state electrolyte powder with a passivation layer on its surface. The present invention also provides a lithium-ion cell comprising the garnet-type solid-state electrolyte powder.

### Descriptions of the Related Art

In response to global warming and climate change, implementing energy conservation and carbon reduction is currently a primary goal. Enhancing energy storage efficiency is a key issue in energy conservation. Lithium-ion cells are one of the most widely used energy storage systems. However, conventional lithium-ion cells use liquid-state electrolytes, which pose safety issues such as short circuits and even explosion caused by leakage and metal dendrites breaking through separator. Consequently, recent research on lithium-ion cells has focused on solid-state electrolytes. Garnet-type solid-state electrolytes are one of promisingly important solid-state electrolytes due to their high mechanical strength, high ionic conductivity (about 10⁻³ S/cm to 10⁻⁴ S/cm) and high chemical stability.

However, garnet-type solid-state electrolytes readily react with carbon dioxide (CO₂) and water (H₂O) in air to generate an excessive lithium carbonate (Li₂CO₃) layer on their surface. This excessive lithium carbonate layer causes a decrease in the ionic conductivity between a garnet-type ceramic electrolyte sheet and lithium metal, thereby affecting the overall performance of the lithium-ion cell. Even the excess lithium carbonate layer is completely removed, as long as the garnet-type solid-state electrolyte is placed in an environment comprising water and carbon dioxide, an excessive lithium carbonate (Li₂CO₃) layer will still grow on its surface.

### SUMMARY OF THE INVENTION

In view of the above technical issues, the present invention provides a garnet-type solid-state electrolyte powder with a passivation layer on its surface, thereby avoiding lithium carbonate layer excessively generated on the surface of the garnet-type solid-state electrolyte powder. The garnet-type solid-state electrolyte powder of the present invention can be provided with improved stability, thereby being favorable to long-term storage and applications in solid-state lithium-ion cell.

Thus, an objective of the present invention is to provide a garnet-type solid-state electrolyte powder, which is a lithium lanthanum zirconium oxide-based solid-state electrolyte powder with a passivation layer on its surface, wherein the thickness of the passivation layer is greater than 0 nm and 10 nm or less.

In one embodiment of the present invention, the passivation layer is a lithium carbonate (Li₂CO₃) passivation layer.

In one embodiment of the present invention, the passivation layer is an in-situ formed passivation layer.

In one embodiment of the present invention, the garnet-type solid-state electrolyte powder has a lithium carbonate variation of less than 1% after being stored for 24 hours in an air atmosphere with a humidity of 60%, wherein the lithium carbonate variation is determined based on the change in the characteristic peak signal of lithium carbonate in the Raman spectrum of the garnet-type solid-state electrolyte powder before and after the 24-hour storage under the said air atmosphere.

In one embodiment of the present invention, the garnet-type solid-state electrolyte powder is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂, and combinations thereof.

In one embodiment of the present invention, the garnet-type solid-state electrolyte powder has a D50 particle size larger than 500 nm and less than 100 μm.

Another objective of the present invention is to provide a lithium-ion cell, which comprises a positive electrode, a negative electrode, and a solid-state electrolyte, wherein the solid-state electrolyte comprises the aforementioned garnet-type solid-state electrolyte powder.

In one embodiment of the present invention, the positive electrode is made of a material selected from the group consisting of LiFePO₄ (LFP), LiCoO₂ (LCO), lithium nickel cobalt aluminum oxide (NCA), and lithium nickel cobalt manganese oxide (NCM).

In one embodiment of the present invention, the negative electrode is made of a material selected from the group consisting of lithium metal, a lithium-indium alloy, a lithium-aluminum alloy, a silicon-lithium alloy, and combinations thereof.

Yet another objective of the present invention is to provide a method of preparing the aforementioned garnet-type solid-state electrolyte powder, which comprises the following steps:

placing a garnet-type solid-state electrolyte powder in an atmosphere containing water and carbon dioxide to form a lithium carbonate layer in-situ on the surface of the garnet-type solid-state electrolyte powder until the formation of lithium carbonate ceases; and

partially removing lithium carbonate from the surface of the lithium carbonate layer until the thickness of the lithium carbonate layer is reduced to a range of larger than 0 nm to 10 nm, thereby obtaining the lithium carbonate passivation layer.

In one embodiment of the present invention, the step of partially removing lithium carbonate from the surface of the lithium carbonate layer is performed by at least one of a solvent cleaning treatment and an ultrasonic treatment, wherein the solvent used in the solvent cleaning treatment is selected from the group consisting of ultrapure water, ethanoic acid (CH₃COOH), methanoic acid (HCOOH), hydrochloric acid (HCl), oxalic acid (C₂H₂O₄), phosphoric acid (H₃PO₄), sulfurous acid (H₂SO₃), carbonic acid (H₂CO₃), nitrous acid (HNO₂), and combinations thereof.

To render the above objectives, technical features and advantages of the present invention more apparent, the present invention will be described in detail with reference to some embodiments hereinafter.

### BRIEF DESCRIPTION OF THE DRAWINGS

FIG. 1 is a transmission electron microscope (TEM) image of the garnet-type solid-state electrolyte powder of Comparative Example 1.

FIG. 2 is a TEM image of the garnet-type solid-state electrolyte powder of Comparative Example 2.

FIG. 3 is a TEM image of the garnet-type solid-state electrolyte powder of Example 1.

FIG. 4 shows the spectra of the garnet-type solid-state electrolyte powders of Example 1, Comparative Example 1 and Comparative Example 2 via Fourier-transform infrared spectroscopy (FTIR).

FIG. 5 shows the Raman spectra of the garnet-type solid-state electrolyte powders of Comparative Example 1 and Comparative Example 2.

FIG. 6 shows the Raman spectra of the garnet-type solid-state electrolyte powders of Example 1 and Comparative Example 1

### DESCRIPTION OF THE PREFERRED EMBODIMENTS

Hereinafter, some embodiments of the present invention will be described in detail. However, the present invention may be embodied in various embodiments and should not be limited to the embodiments described in the specification.

In the appended drawings, similar elements are denoted by similar reference numerals. The thickness of each layer and region may be exaggerated for clarity. Unless otherwise explained, when a layer is described as being "on" another layer or a substrate, the layer can be directly on the another layer or substrate, or one or more intervening layers may be present therebetween.

Unless otherwise specified, the expressions "a," "the," or the like recited in the specification and in the claims should include both the singular and the plural forms.

In the specification and claims, the numerical range used (e.g., 5 to 100) should be understood to include all rational numbers in the range and ranges consisting of any rational number in the range. Therefore, the numerical range used in the specification should include all possible combinations of numerical values between the lowest value and the highest value listed.

Unless otherwise specified, in the specification and the claims, the term "positive electrode" refers to the cathode in a cell during discharge, and the term "negative electrode" refers to the anode in a cell during discharge.

Unless otherwise specified, in the specification and the claims, the expression "do/does not contain lithium carbonate" means that the content of lithium carbonate in the garnet-type solid-state electrolyte powder confirmed by using the Raman spectroscopy is 0 ppm or less than 0.1 ppm.

The advantage of the present invention over the prior art lies in that the surface of the garnet-type solid-state electrolyte powder is provided with a passivation layer of a specific thickness. This avoids the excessive formation of lithium carbonate on the surface of the garnet-type solid-state electrolyte powder, thereby enhancing the stability of said powder and facilitating long-term storage and applications in solid-state lithium-ion cells. Detailed descriptions of the garnet-type solid-state electrolyte powder and related applications of the present invention are provided below.

### 1. Garnet-type solid-state electrolyte powder

Garnet-type solid-state electrolyte is a type of oxide-type electrolytes, with Li₇La₃Zr₂O₁₂ (LLZO) being a representative example. In general, garnet-type solid-state electrolytes exist in a high-temperature metastable cubic phase and a low-temperature/room-temperature stable tetragonal phase. In the tetragonal phase, the lithium sites are fully (100%) occupied, whereas the cubic phase contains lithium vacancies, resulting in the ionic conductivity of the tetragonal phase garnet being two orders of magnitude lower than that of the cubic phase garnet. One method to stabilize the cubic phase garnet is by directly doping to substitute Li⁺, thereby generating lithium vacancies. Another method involves substituting Zr⁴⁺ with high-valence ions, which can stabilize the cubic phase garnet and achieve a high ionic conductivity approaching 10⁻³ S/cm. In the present invention, the garnet-type solid-state electrolyte powder is lithium lanthanum zirconium oxide-based ceramic powder. Examples of the lithium lanthanum zirconium oxide-based ceramic powder include, but are not limited to, LLZTO, LLZAO, LLZGO, and Li_{6.25}Al_{0.20}La₃Zr_{1.85}Nb_{0.15}O₁₂. The aforementioned lithium lanthanum zirconium oxide-based ceramic powders can be used individually or in any combination. In the appended examples, LLZTO powder is used.

In one embodiment of the present invention, the garnet-type solid-state electrolyte powder has a D50 particle size larger than 500 nm and less than 100 μm. For example, the D50 particle size of the garnet-type solid-state electrolyte powder can be 501 nm, 600 nm, 700 nm, 800 nm, 900 nm, 1 µm, 5 µm, 10 µm, 15 µm, 20 µm, 25 µm, 30 µm, 35 µm, 40 µm, 45 µm, 50 µm, 55 µm, 60 µm, 65 µm, 70 µm, 75 µm, 80 µm, 85 µm, 90 µm, 95 µm, or 99 µm, or within a range between any two of the values described herein.

One feature of the present invention lies in that the garnet-type solid-state electrolyte powder has a passivation layer on its surface. The thickness of the passivation layer is greater than 0 nm and 10 nm or less. For example, the thickness of the passivation layer can be 0.1 nm, 0.2 nm, 0.3 nm, 0.4 nm, 0.5 nm, 0.6 nm, 0.7 nm, 0.8 nm, 0.9 nm, 1.0 nm, 1.1 nm, 1.2 nm, 1.3 nm, 1.4 nm, 1.5 nm, 1.6 nm, 1.7 nm, 1.8 nm, 1.9 nm, 2.0 nm, 2.1 nm, 2.2 nm, 2.3 nm, 2.4 nm, 2.5 nm, 2.6 nm, 2.7 nm, 2.8 nm, 2.9 nm, 3.0 nm, 3.1 nm, 3.2 nm, 3.3 nm, 3.4 nm, 3.5 nm, 3.6 nm, 3.7 nm, 3.8 nm, 3.9 nm, 4.0 nm, 4.1 nm, 4.2 nm, 4.3 nm, 4.4 nm, 4.5 nm, 4.6 nm, 4.7 nm, 4.8 nm, 4.9 nm, 5.0 nm, 5.1 nm, 5.2 nm, 5.3 nm, 5.4 nm, 5.5 nm, 5.6 nm, 5.7 nm, 5.8 nm, 5.9 nm, 6.0 nm, 6.1 nm, 6.2 nm, 6.3 nm, 6.4 nm, 6.5 nm, 6.6 nm, 6.7 nm, 6.8 nm, 6.9 nm, 7.0 nm, 7.1 nm, 7.2 nm, 7.3 nm, 7.4 nm, 7.5 nm, 7.6 nm, 7.7 nm, 7.8 nm, 7.9 nm, 8.0 nm, 8.1 nm, 8.2 nm, 8.3 nm, 8.4 nm, 8.5 nm, 8.6 nm, 8.7 nm, 8.8 nm, 8.9 nm, 9.0 nm, 9.1 nm, 9.2 nm, 9.3 nm, 9.4 nm, 9.5 nm, 9.6 nm, 9.7 nm, 9.8 nm, 9.9 nm, or 10.0 nm, or within a range between any two of the values described herein.

The passivation effect provided by the passivation layer prevents lithium carbonate from further growing on the surface of the garnet-type solid-state electrolyte powder even when the garnet-type solid-state electrolyte powder is placed in an atmosphere containing water and carbon dioxide. In general, the relative content of lithium carbonate can be confirmed by analyzing the intensity of the lithium carbonate characteristic peak signal in the garnet-type solid-state electrolyte powder via Raman spectroscopy. In one embodiment of the present invention, the garnet-type solid-state electrolyte powder has a lithium carbonate variation of less than 1% after being stored for 24 hours in an air atmosphere with a humidity of 60%. For example, the lithium carbonate variation can be 0.9%, 0.8%, 0.7%, 0.6%, 0.5%, 0.4%, 0.3%, 0.2%, 0.1%, or 0%, or within a range between any two of the values described herein. The lithium carbonate variation is determined based on the change in the characteristic peak signal of lithium carbonate in the Raman spectrum of the garnet-type solid-state electrolyte powder before and after the 24-hour storage under the said air atmosphere. Specifically, the relative content of lithium carbonate before the 24-hour storage is obtained by detecting the characteristic peak signal of lithium carbonate in the garnet-type solid-state electrolyte powder using a Raman spectrometer and calculating the integrated area via the associated software. Next, the garnet-type solid-state electrolyte powder is stored in an air atmosphere with 60% humidity for 24 hours. Then, the characteristic peak signal of lithium carbonate in the garnet-type solid-state electrolyte powder is detected again by using the Raman spectrometer and the integrated area of the characteristic peak signal is calculated via the associated software to determine the relative content of lithium carbonate after the 24-hour storage, and the amount of lithium carbonate variation is calculated accordingly. The Raman spectrometer used may be a DXR Raman Microscope available from Thermo Fisher Scientific, with detection conditions featuring a 532 nm laser source and a laser power of 10 mW.

In one embodiment of the present invention, the passivation layer is a lithium carbonate passivation layer. More specifically, the passivation layer is an in-situ formed passivation layer. The expression "in-situ formed" means that, lithium contained in the garnet-type solid-state electrolyte powder reacts with water and carbon dioxide in the surrounding environment and directly forms a lithium carbonate layer on the surface of the garnet-type solid-state electrolyte powder, which is the in-situ formed lithium carbonate layer.

In general, as long as the environment where the garnet-type solid-state electrolyte powders are placed contains water and carbon dioxide, then lithium carbonate would constantly grow on the surface of the garnet-type solid-state electrolyte powder in a random and loose manner, until a complete and uniform lithium carbonate layer is formed on the surface of the garnet-type solid-state electrolyte powder and the lithium contained in the garnet-type solid-state electrolyte powder can no longer be contact with water and carbon dioxide in the environment. The present invention ingeniously utilizes the aforementioned mechanism to first form complete and uniform lithium carbonate layer on the surface of the garnet-type solid-state electrolyte powder, and then intentionally removes the outer portion of the lithium carbonate layer by, for example, applying a physical force (e.g., an ultrasonic oscillation) or acid washing, to retain only the uniform lithium carbonate layer closely near the surface of the garnet-type solid-state electrolyte powder. As a result, on one hand, the retained lithium carbonate layer provides passivation functionality to prevent further formation of lithium carbonate; one the other hand, it effectively avoids a decrease in ionic conductivity between the garnet-type ceramic electrolyte sheet and lithium metal caused by an excessively thick lithium carbonate layer, which would otherwise impair the overall performance of the lithium-ion cell. Therefore, by utilizing the passivation layer, the present invention achieves the technical effects of enhancing the stability of the garnet-type solid-state electrolyte powder while avoiding a significant reduction in ionic conductivity. The above approach represents an unprecedented innovation. While prior arts have focused on how to prevent the formation of lithium carbonate on the surface of the garnet-type solid-state electrolyte powder, or how to effectively and completely remove the formed lithium carbonate, none have conceived of utilizing lithium carbonate to form a passivation layer possessing passivation functionality.

### 2. Method of preparing garnet-type solid-state electrolyte powder

The present invention also provides a method of preparing the aforementioned garnet-type solid-state electrolyte powder, which comprises the following steps:

placing a garnet-type solid-state electrolyte powder in an atmosphere containing water and carbon dioxide to form a lithium carbonate layer in-situ on the surface of the garnet-type solid-state electrolyte powder until the formation of lithium carbonate ceases; and

partially removing lithium carbonate from the surface of the lithium carbonate layer until the thickness of the lithium carbonate layer is reduced to a range of larger than 0 nm to 10 nm, thereby obtaining the lithium carbonate passivation layer.

In the step of forming a lithium carbonate layer in-situ on the surface of the garnet-type solid-state electrolyte powder until the formation of lithium carbonate ceases, whether the formation of lithium carbonate ceases or not can be determined by using a scanning electronic microscope to confirm that there is no change in the thickness of the in-situ formed lithium carbonate layer.

In the step of partially removing lithium carbonate from the surface of the lithium carbonate layer, the partially removal can be performed by, for example, a solvent cleaning treatment and/or an ultrasonic treatment. Partially removal of lithium carbonate is preferably performed by a combination of the solvent cleaning treatment and the ultrasonic treatment. Examples of the solvent that can be used in the solvent cleaning treatment (hereinafter "the cleaning solvent") include, but are not limited to ultrapure water, ethanoic acid (CH₃COOH), methanoic acid (HCOOH), hydrochloric acid (HCl), oxalic acid (C₂H₂O₄), phosphoric acid (H₃PO₄), sulfurous acid (H₂SO₃), carbonic acid (H₂CO₃), and nitrous acid (HNO₂). The aforementioned cleaning solvents can be used individually or in any combination. In general, when ultrapure water is used alone as the cleaning solvent, the ultrasonic treatment is typically applied to facilitate the removal of lithium carbonate. In the case that the aforementioned organic acids or inorganic acids are used, the concentration of those acids is not particularly limited (excluding ultrapure water). In general, the concentration of the aforementioned organic acids or inorganic acids can range from 0.1 M to 2.0 M. For example, the concentration of the aforementioned organic acids or inorganic acids can be 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, or 2.0 M, or within a range between any two of the values described herein. In the case where the ultrasonic treatment is used alone to partially remove lithium carbonate, the duration of the ultrasonic treatment may range from 1 (one) minute to 8 minutes. In the case where the solvent cleaning treatment and the ultrasonic treatment are used in combination to partially remove lithium carbonate, the duration of the ultrasonic treatment may be reduced to 1 (one) second to 8 seconds. In the case where the solvent cleaning treatment is used alone to partially remove lithium carbonate, the duration of the solvent cleaning treatment may range from 1 (one) minute to 8 minutes.

In one embodiment of the present invention, the solvent cleaning treatment and the ultrasonic treatment are used in combination to partially remove lithium carbonate from the surface of the lithium carbonate layer. First, after the formation of lithium carbonate on the surface of the garnet-type solid-state electrolyte powder in an atmosphere containing water and carbon dioxide ceases, the garnet-type solid-state electrolyte powder is added into an organic solvent, followed by adding a cleaning solvent to obtain an initial mixed solution. Then, the initial mixed solution is subjected to an ultrasonic oscillation until the thickness of the in-situ formed lithium carbonate layer is reduced to a range of larger than 0 nm to 10 nm. After reaching the aforementioned thickness, the ultrasonic oscillation is terminated and a certain amount of ultrapure water is added therein to cease the solvent cleaning treatment. Next, the initial mixed solution after the ultrasonic oscillation is placed in a centrifugal machine for centrifugation. The precipitate obtained after centrifugation is the garnet-type solid-state electrolyte powder having a lithium carbonate passivation layer with a thickness that is greater than 0 nm and 10 nm or less. Examples of the organic solvent include, but are not limited to ethanol, isopropanol, and acetone. The aforementioned organic solvents can be used individually or in any combination.

### 3. Lithium-ion cell

The garnet-type solid-state electrolyte powder of the present invention can be used in a cell, such as a lithium-ion cell. Thus, the present invention also provides a lithium-ion cell, which comprises a positive electrode, a negative electrode, and a solid-state electrolyte, wherein the solid-state electrolyte comprises the aforementioned garnet-type solid-state electrolyte powder. The manufacturing process of the solid-state electrolyte from the solid-state electrolyte powder can be carried out by persons having ordinary skill in the art based on the prior art, and thus is omitted here.

The positive electrode usable for the lithium-ion cell can be made of a material selected from LFP, mono lithium cathode materials, binary lithium cathode materials, and ternary lithium cathode materials. Examples of the mono lithium cathode materials include, but are not limited to, LCO, lithium nickel oxide, and lithium manganese oxide. Examples of the binary lithium cathode materials include, but are not limited to, lithium nickel cobalt oxide, LNMO (lithium nickel manganese oxide), and lithium manganese cobalt oxide. Examples of the ternary lithium cathode materials include, but are not limited to, NCA and NCM. In one embodiment of the present invention, the positive electrode is made of a material selected from the group consisting of LFP, LCO, NCA, and NCM. Examples of NCA include, but are not limited to, LiNi_{0.8}Co_{0.15}Al_{0.05}O₂, LiNi_{0.8}Co_{0.18}Al_{0.02}O₂, and LiNi_{0.9}Co_{0.05}Al_{0.05}O₂. Examples of NCM include, but are not limited to, LiNi_{0.33}Co_{0.33}Mn_{0.33}O₂ (NCM111), LiNi_{0.5}Co_{0.2}Mn_{0.3}O₂ (NCM523), LiNi_{0.6}Co_{0.2}Mn_{0.2}O₂ (NCM622) and LiNi_{0.8}Co_{0.1}Mn_{0.1}O₂ (NCM811). The aforementioned positive electrode materials can be used individually or in any combination.

The negative electrode of the lithium-ion cell can be made of a material selected from lithium metal, a lithium-indium alloy, a lithium-aluminum alloy, and a silicon-lithium alloy. The aforementioned materials for making the negative electrode can be used individually or in any combination. In the appended examples, the material of the negative electrode is lithium.

### 4 . Example s

### 4 .1. Preparation of garnet-type solid-state electrolyte powder

### Comparative Example 1

First, 250 mg of Li_{6.4}La₃Zr_{1.4}Ta_{0.6}O₁₂ (LLZTO) powder was prepared as the garnet-type solid-state electrolyte powder of Comparative Example 1.

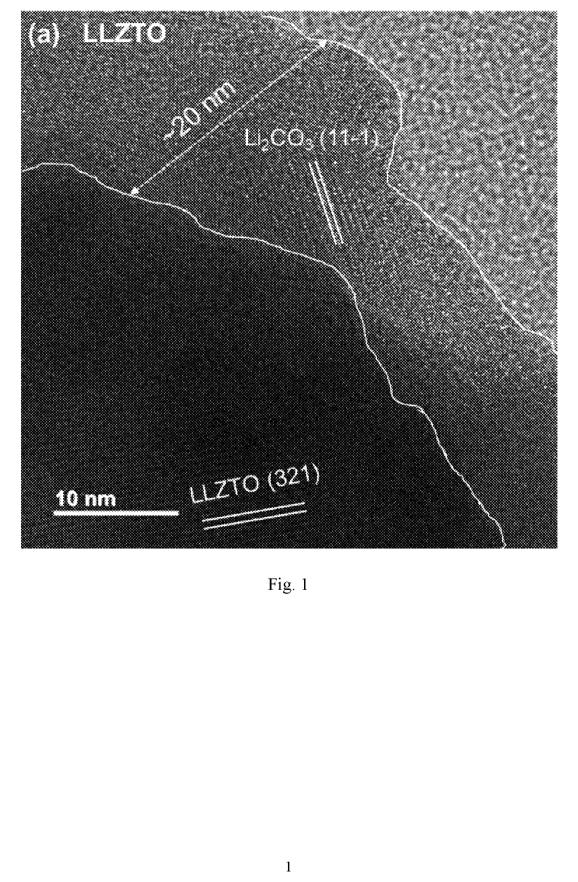

20 mg of the garnet-type solid-state electrolyte powder of Comparative Example 1 was dissolved in 1 (one) mL of ethanol to obtain a mixture solution. Then, the mixture solution was dripped onto a carbon-plated copper mesh to prepare a test sample of Comparative Example 1. The test sample of Comparative Example 1 was photographed using a transmission electron microscope (model no.: JEM-2100F, available from JEOL), and the resulting image is shown in FIG. 1. As shown in FIG. 1, it can be observed that the surface of the garnet-type solid-state electrolyte powder of Comparative Example 1 has a non-uniform lithium carbonate layer with a thickness of about 20 nm.

### Comparative Example 2

The garnet-type solid-state electrolyte powder of Comparative Example 1 was subjected to a solvent cleaning treatment and an ultrasonic treatment. First, the garnet-type solid-state electrolyte powder of Comparative Example 1 was added into a mixed solvent including 1 (one) mL of ethanol and 3 mL of isopropanol and mixed well to form a uniform dispersion solution. Then, the dispersion solution was mixed with 5 mL of 1 M hydrochloric acid to obtain an initial mixed solution. Afterwards, the initial mixed solution was subjected to an ultrasonic oscillation in an ultrasonic oscillator for 10 seconds, followed by adding 10 mL of ultrapure water therein for diluting hydrochloric acid. Then, the diluted mixed solution was placed in a centrifugal machine for centrifugation at a rotational speed of 8000 rpm for 10 minutes. The precipitate obtained after centrifugation was collected and dried in a vacuum environment for 24 hours to obtain the garnet-type solid-state electrolyte powder of Comparative Example 2.

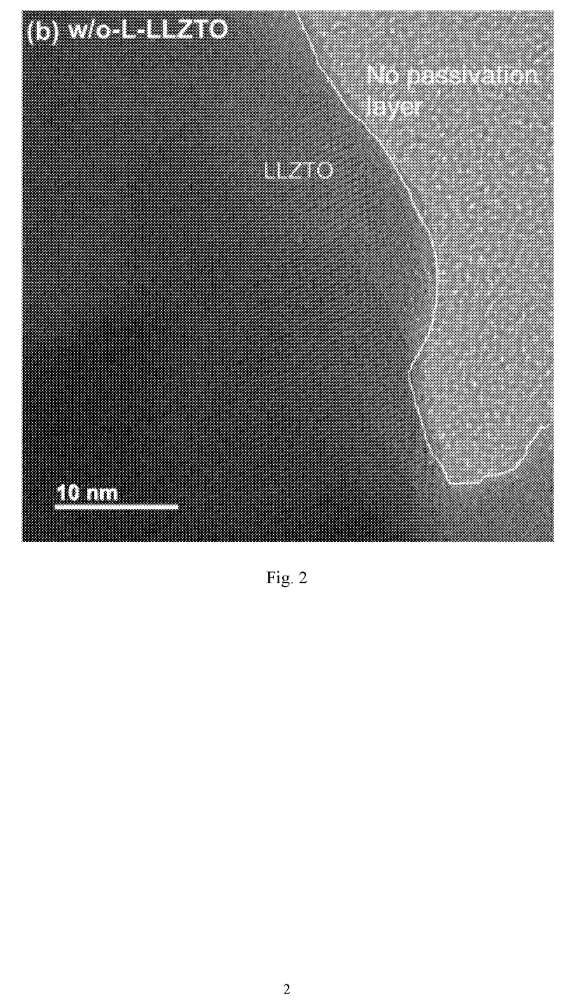

20 mg of the garnet-type solid-state electrolyte powder of Comparative Example 2 was dissolved in 1 (one) mL of ethanol to obtain a mixture solution. Then, the mixture solution was dripped onto a carbon-plated copper mesh to prepare a test sample of Comparative Example 2. The test sample of Comparative Example 2 was photographed using a transmission electron microscope JEM-2100F, and the resulting image is shown in FIG. 2. As shown in FIG. 2, it can be observed that the surface of the garnet-type solid-state electrolyte powder of Comparative Example 2 does not have a lithium carbonate layer.

### Example 1

The garnet-type solid-state electrolyte powder of Comparative Example 1 was subjected to a solvent cleaning treatment and an ultrasonic treatment. First, the garnet-type solid-state electrolyte powder of Comparative Example 1 was added into a mixed solvent including 1 (one) mL of ethanol and 3 mL of isopropanol and mixed well to form a uniform dispersion solution. Then, the dispersion solution was mixed with 5 mL of 1 M hydrochloric acid to obtain an initial mixed solution. Afterwards, the initial mixed solution was subjected to an ultrasonic oscillation in an ultrasonic oscillator for 5 seconds, followed by adding 10 mL of ultrapure water therein for diluting hydrochloric acid. Then, the diluted mixed solution was placed in a centrifugal machine for centrifugation at a rotational speed of 8000 rpm for 10 minutes. The precipitate obtained after centrifugation was collected and dried in a vacuum environment for 24 hours to obtain the garnet-type solid-state electrolyte powder of Example 1 with a passivation layer on its surface.

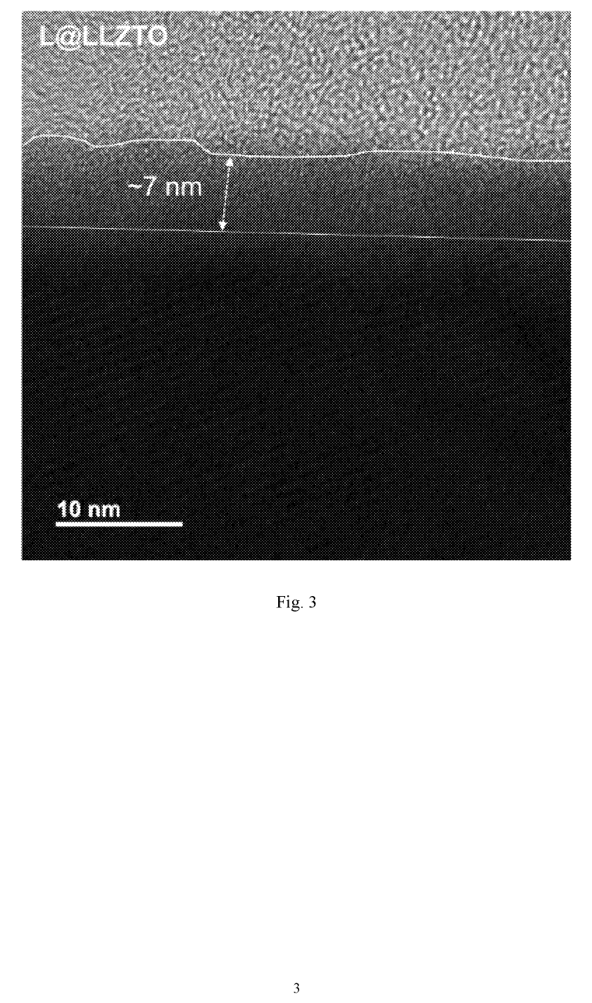

20 mg of the garnet-type solid-state electrolyte powder of Example 1 was dissolved in 1 (one) mL of ethanol to obtain a mixture solution. Then, the mixture solution was dripped onto a carbon-plated copper mesh to prepare a test sample of Example 1. The test sample of Example 1 was photographed using a transmission electron microscope JEM-2100F, and the resulting image is shown in FIG. 3. As shown in FIG. 3, it can be observed that the surface of the garnet-type solid-state electrolyte powder of Example 1 has a uniform lithium carbonate passivation layer with a thickness of about 7 nm.

### Analysis of Fourier-transform infrared spectroscopy

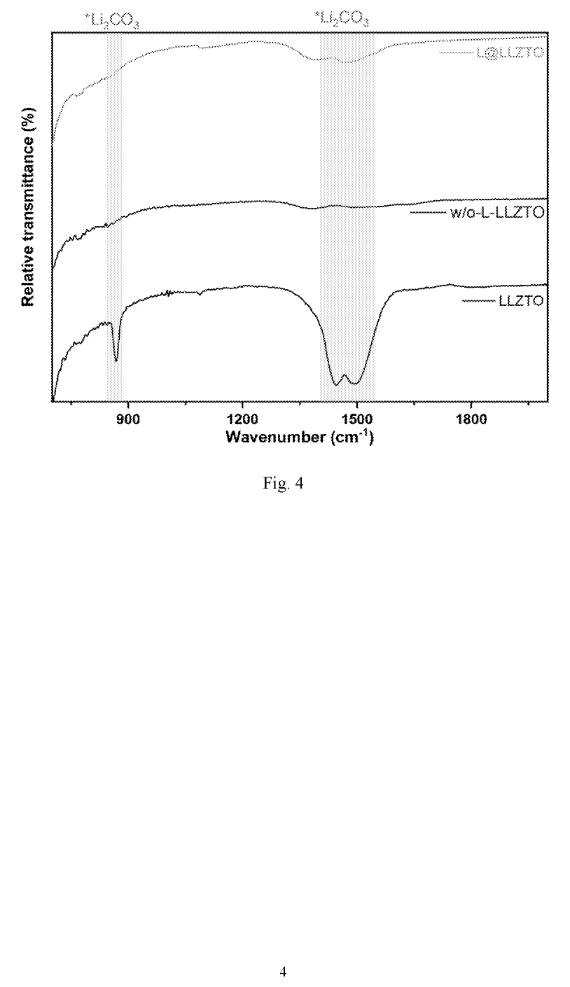

Each of the garnet-type solid-state electrolyte powder of Example 1, Comparative Example 1 and Comparative Example 2 was subjected to FTIR analysis using a Fourier-transform infrared spectroscope (model no.: FTIR-4X, available from JASCO (Nihon Bunko)), and the results are shown in FIG. 4. In FIG. 4, the garnet-type solid-state electrolyte powders of Example 1, Comparative Example 1 and Comparative Example 2 are represented by "LLZTO", "w/o-L-LLZTO", and "L@LLZTO", respectively.

As shown in FIG. 4, after FTIR analysis, the garnet-type solid-state electrolyte powder of Comparative Example 1 without being subjected to any treatment (represented by "LLZTO") exhibits strong signals of absorption peak of carbon-oxygen single bond (C-O) and carbonyl (C=O) at 850 cm⁻¹ and 1400 cm⁻¹ in the spectrum, respectively, indicating the presence of lithium carbonate. This confirms that the garnet-type solid-state electrolyte powder of Comparative Example 1 contains lithium carbonate, a result that corresponds to FIG. 1. After FTIR analysis, the garnet-type solid-state electrolyte powder of Comparative Example 2 with being subjected to lithium carbonate removal treatment (represented by "w/o-L-LLZTO") exhibits no signals of absorption peak at 850 cm⁻¹ and 1400 cm⁻¹ in the spectrum, indicating the absence of lithium carbonate. This confirms that the garnet-type solid-state electrolyte powder of Comparative Example 2 does not contain lithium carbonate upon completion of its preparation, a result that corresponds to FIG. 2. After FTIR analysis, the garnet-type solid-state electrolyte powder of Example 1 with being subjected to passivation layer forming treatment (represented by "L@LLZTO") exhibits weak signals of absorption peak of carbon-oxygen single bond (C-O) and carbonyl (C=O) at 850 cm⁻¹ and 1400 cm⁻¹ in the spectrum, respectively, indicating a small content of lithium carbonate. This confirms that the garnet-type solid-state electrolyte powder of Example 1 contains a small content of lithium carbonate, a result corresponds to FIG. 3.

### Raman spectral analysis

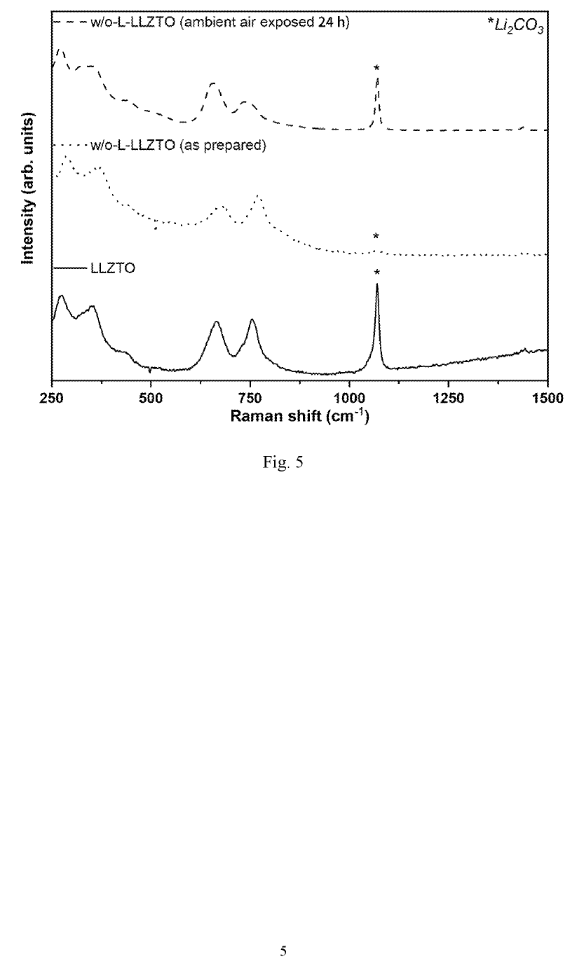

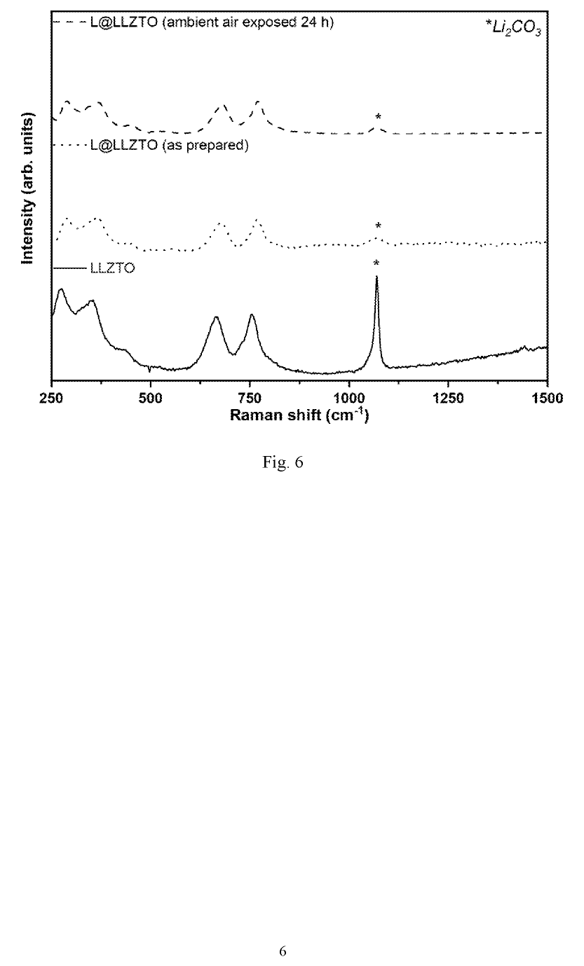

The garnet-type solid-state electrolyte powder of Comparative Example 1 was subjected to a surface analysis using a Raman spectrometer (model no.: DXR Raman Microscope, available from Thermo Fisher Scientific) with a 532 nm laser source and a laser power of 10 mW. The result is shown in FIGS. 5 and FIG. 6 for comparison, represented by "LLZTO". In addition, the garnet-type solid-state electrolyte powder of Comparative Example 2 was subjected to a surface analysis using the Raman spectrometer DXR Raman Microscope, and the result is shown in FIG. 5, represented by "w/o-L-LLZTO (as prepared)". Then, after the garnet-type solid-state electrolyte powder of Comparative Example 2 being exposed to ambient air containing moisture and carbon dioxide for 24 hours, the garnet-type solid-state electrolyte powder of Comparative Example 2 was again subjected to a surface analysis using the Raman spectrometer DXR Raman Microscope, and the result is shown in FIG. 5, represented by "w/o-L-LLZTO (ambient air exposed 24h)". As shown in FIG. 5, compared to LLZTO, no characteristic signal of lithium carbonate at 1074 cm⁻¹ was detected in the garnet-type solid-state electrolyte powder of Comparative Example 2 upon completion of its preparation (represented by "w/o-L-LLZTO (as prepared)"). This testifies that lithium carbonate has been completely removed. However, after the exposure to ambient air for 24 hours, a strong signal at 1074 cm⁻¹ was detected for the garnet-type solid-state electrolyte powder of Comparative Example 2 (represented by "w/o-L-LLZTO (ambient air exposed 24h)"). This reveals that lithium carbonate grows again. The result of Comparative Example 2 testifies that, even lithium carbonate on the surface of the garnet-type solid-state electrolyte powder is completely removed, it will grow again as long as the environment where the garnet-type solid-state electrolyte powder exists contains moisture and carbon dioxide. Thus, the stability of the garnet-type solid-state electrolyte powder of Comparative Example 2 is poor.

The garnet-type solid-state electrolyte powder of Example 1 was subjected to a surface analysis using the Raman spectrometer DXR Raman Microscope, and the result is shown in FIG. 6, represented by "L@LLZTO (as prepared)". Then, after the garnet-type solid-state electrolyte powder of Example 1 being exposed to ambient air containing moisture and carbon dioxide for 24 hours, the garnet-type solid-state electrolyte powder of Example 1 was again subjected to a surface analysis using the Raman spectrometer DXR Raman Microscope, and the result is shown in FIG. 6, represented by "L@LLZTO (ambient air exposed 24h)". As shown in FIG. 6, compared to LLZTO, a weak characteristic signal of lithium carbonate at 1074 cm⁻¹ was detected for the garnet-type solid-state electrolyte powder of Example 1 upon preparation (represented by "L@LLZTO (as prepared)"). This testifies that the garnet-type solid-state electrolyte powder of Example 1 contains a small content of lithium carbonate. Furthermore, as can be clearly observed from FIG. 6, even the garnet-type solid-state electrolyte powder of Example 1 was exposed to ambient air for 24 hours (represented by "L@LLZTO (ambient air exposed 24h)"), there is no apparent variation in the intensity of the characteristic signal of lithium carbonate at 1074 cm⁻¹. This indicates that there is no apparent variation in content of lithium carbonate, meaning that no new lithium carbonate forms. This result confirms that the garnet-type solid-state electrolyte powder of the present invention, which features the passivation layer on its surface, prevents the formation of new lithium carbonate even during long-term storage in an atmosphere containing moisture and carbon dioxide. This demonstrates superior stability, which is highly advantageous for the commercial application of solid-state electrolyte.

The above examples are used to illustrate the principle and efficacy of the present invention and show the inventive features thereof, but are not used to limit the scope of the present invention. People skilled in this field may proceed with a variety of modifications and replacements based on the disclosures and suggestions of the invention as described. Therefore, the scope of protection of the present invention is that as defined in the claims as appended.

What is claimed is:

1. A garnet-type solid-state electrolyte powder, which is a lithium lanthanum zirconium oxide-based solid-state electrolyte powder with a passivation layer on its surface, wherein the thickness of the passivation layer is greater than 0 nm and 10 nm or less.

2. The garnet-type solid-state electrolyte powder of claim 1, wherein the passivation layer is a lithium carbonate (Li₂CO₃) passivation layer.

3. The garnet-type solid-state electrolyte powder of claim 2, wherein the passivation layer is an in-situ formed passivation layer.

4. The garnet-type solid-state electrolyte powder of claim 1, which has a lithium carbonate variation of less than 1% after being stored for 24 hours in an air atmosphere with a humidity of 60%, wherein the lithium carbonate variation is determined based on the change in the characteristic peak signal of lithium carbonate in the Raman spectrum of the garnet-type solid-state electrolyte powder before and after the 24-hour storage under the said air atmosphere.

5. The garnet-type solid-state electrolyte powder of claim 1, wherein the garnet-type solid-state electrolyte powder is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ and combinations thereof.

6. The garnet-type solid-state electrolyte powder of claim 2, wherein the garnet-type solid-state electrolyte powder is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ and combinations thereof.

7. The garnet-type solid-state electrolyte powder of claim 3, wherein the garnet-type solid-state electrolyte powder is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ and combinations thereof.

8. The garnet-type solid-state electrolyte powder of claim 4, wherein the garnet-type solid-state electrolyte powder is selected from the group consisting of Li_{6.4}La₃Zr_{1.4}Ta_{0.6}O₁₂ (LLZTO), Li_{6.4}La₃Zr₂Al_{0.2}O₁₂ (LLZAO), Li_{6.4}La₃Zr₂Ga_{0.2}O₁₂ (LLZGO), Li_{6.25}Al_{0.20}La₃Zr_{1.85}Nb_{0.15}O₁₂ and combinations thereof.

9. The garnet-type solid-state electrolyte powder of claim 1, wherein the garnet-type solid-state electrolyte powder has a D50 particle size larger than 500 nm and less than 100 μm.

10. The garnet-type solid-state electrolyte powder of claim 2, wherein the garnet-type solid-state electrolyte powder has a D50 particle size larger than 500 nm and less than 100 μm.

11. The garnet-type solid-state electrolyte powder of claim 3, wherein the garnet-type solid-state electrolyte powder has a D50 particle size larger than 500 nm and less than 100 μm.

12. The garnet-type solid-state electrolyte powder of claim 4, wherein the garnet-type solid-state electrolyte powder has a D50 particle size larger than 500 nm and less than 100 μm.

13. A lithium-ion cell, which comprises a positive electrode, a negative electrode, and a solid-state electrolyte, wherein the solid-state electrolyte comprises the garnet-type solid-state electrolyte powder of claim 1.

14. The lithium-ion cell of claim 13, wherein the positive electrode is made of a material selected from the group consisting of LiFePO₄ (LFP), LiCoO₂ (LCO), lithium nickel cobalt aluminum oxide (NCA), and lithium nickel cobalt manganese oxide (NCM).

15. The lithium-ion cell of claim 13, wherein the negative electrode is made of a material selected from the group consisting of lithium metal, a lithium-indium alloy, a lithium-aluminum alloy, a silicon-lithium alloy, and combinations thereof.

16. The lithium-ion cell of claim 14, wherein the negative electrode is made of a material selected from the group consisting of lithium metal, a lithium-indium alloy, a lithium-aluminum alloy, a silicon-lithium alloy, and combinations thereof.

17. A method of preparing the garnet-type solid-state electrolyte powder of claim 1, which comprises the following steps:
placing a garnet-type solid-state electrolyte powder in an atmosphere containing water and carbon dioxide to form a lithium carbonate layer in-situ on the surface of the garnet-type solid-state electrolyte powder until the formation of lithium carbonate ceases; and
partially removing lithium carbonate from the surface of the lithium carbonate layer until the thickness of the lithium carbonate layer is reduced to a range of larger than 0 nm to 10 nm, thereby obtaining the lithium carbonate passivation layer.

18. The method of claim 17, wherein the step of partially removing lithium carbonate from the surface of the lithium carbonate layer is performed by at least one of a solvent cleaning treatment and an ultrasonic treatment, wherein the solvent used in the solvent cleaning treatment is selected from the group consisting of ultrapure water, ethanoic acid (CH₃COOH), methanoic acid (HCOOH), hydrochloric acid (HCl), oxalic acid (C₂H₂O₄), phosphoric acid (H₃PO₄), sulfurous acid (H₂SO₃), carbonic acid (H₂CO₃), nitrous acid (HNO₂), and combinations thereof.
